(19) United States
(12) Patent Application Publication
(10) Pub. No.: US 2007/0194765 A1
(43) Pub. Date: Aug. 23, 2007

(54) OSCILLATING SIGNAL GENERATION CIRCUIT FOR A MULTI-CHANNEL SWITCHING VOLTAGE CONVERTER

(76) Inventors: Yung-Chih CHEN, Pingtung County (TW); Chih-Chia CHEN, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/307,738

(22) Filed: Feb. 20, 2006

(51) Int. Cl. G05F 1/577

(52) U.S. Cl. 323/267

(57) ABSTRACT

Being applied to a multi-channel switching voltage converter, an oscillating signal generation circuit includes a rectangular wave oscillator, two frequency dividing units, and four oscillators. The rectangular wave oscillator generates a pair of fundamental rectangular waves having an identical fundamental frequency but 180 degrees out of phase with respect to each other. In response to the pair of fundamental rectangular waves, the two frequency dividing units generate two pairs of auxiliary rectangular waves, each pair having an identical auxiliary frequency but 180 degrees out of phase with respect to each other. The auxiliary frequency is equal to a half of the fundamental frequency. In response to the two pairs of auxiliary rectangular waves, the four oscillators generate four oscillating signals wherein each valley of the oscillating signals is triggered by an edge of the auxiliary rectangular waves.

### BACKGROUND OF THE INVENTION

1. Field of the Invention

The present invention relates to an oscillating signal generation circuit and, more particularly, to an oscillating signal generation circuit for a multi-channel switching voltage converter.

2. Description of the Related Art

Typically, a switching voltage converter regulates an input voltage source for supplying an output voltage with a desired voltage level by appropriately controlling a duty cycle of a power switch transistor. Where the output voltage is larger than the input voltage source, the switching voltage converter is generally referred to as a boost converter or regulator. On the other hand, the switching voltage converter is generally referred to as a buck converter or regulator where the output voltage is smaller than the input voltage source. In order to ensure the stability of the output voltage, the switching voltage converter is usually provided with a feedback circuit, which may be classified as either a voltage mode feedback or a current mode feedback. In regarding to the voltage mode feedback, the feedback circuit retrieves a certain ratio of the output voltage for generating a feedback signal. In regarding to the current mode feedback, the feedback circuit generates a feedback signal by using a current sense amplifier to detect an inductor current.

Many of today's electronic system products effectively perform systematic operations and provide desired results by combining a variety of functional modules. Typically, the functional modules incorporated in one electronic system product adopt different DC power supplies, respectively. That is, they are designed to operate with different DC power supply voltages. Since the electronic system product usually has only one input voltage source such as a battery, a plurality of switching voltage converters are necessary to provide a plurality of different output voltages. As a conventional practice, the plurality of switching voltage converters are integrally manufactured in a single semiconductor integrated circuit chip so as to form a multi-channel switching voltage converter for avoiding unnecessary packaging and wiring processes, thereby achieving advantages of low cost and small size as well as reducing parasitic capacitances and inductances. In this case, the plurality of switching voltage converters serve as multiple power supply channels, which are connected in parallel between a common input voltage source and ground and have respective output terminals for providing a plurality of different output voltages.

FIG. 1 is a circuit block diagram showing a conventional multi-channel switching voltage converter 10. Referring to FIG. 1, the multi-channel switching voltage converter 10 has four power supply channels Ch1 to Ch4, respectively for converting a single input voltage source Vin into four output voltages Vₒᵤₜ₁ to Vₒᵤₜ₄. The first power supply channel Ch1 includes a feedback circuit 11-1, an error amplifier 12-1, a pulse-width-modulation (PWM) comparator 13-1, and a switching circuit 14-1. The feedback circuit 11-1 is coupled to the output terminal for generating a feedback signal V_{fb1} representative of the output voltage Vₒᵤₜ₁. The error amplifier 12-1 has an inverting input terminal for receiving the feedback signal V_{fb1}, and a non-inverting input terminal for receiving a predetermined reference voltage V_{ref}. Based on a difference between the feedback signal V_{fb1} and the reference voltage V_{ref}, the error amplifier 12-1 generates an error signal Vₑᵣᵣ₁. The PWM comparator 13-1 has a non-inverting input terminal for receiving the error signal Vₑᵣᵣ₁, and an inverting input terminal for receiving a predetermined oscillating signal OSC. Based on a comparison between the error signal Vₑᵣᵣ₁ and the oscillating signal OSC, the PWM comparator 13-1 generates a switching control signal PWM1. In response to the switching control signal PWM1, the switching circuit 14-1 converts the input voltage source Vin into the output voltage Vₒᵤₜ₁. The duty cycle of the switching control signal PWM1 determines the voltage level converting relationship between the input voltage source Vin and the output voltage Vₒᵤₜ₁. In other words, under a condition that the input voltage source Vin is fixed, the voltage level of the output voltage Vₒᵤₜ₁ can be manipulated by appropriately adjusting the duty cycle of the switching control signal PWM1.

Similarly to the power supply channel Ch1, the power supply channels Ch2 to Ch4 have the feedback circuits 11-2 to 11-4, the error amplifiers 12-2 to 12-4, the PWM comparators 13-2 to 13-4, and the switching circuits 14-2 to 14-4, respectively. The feedback circuits 11-2 to 11-4 generate feedback signals V_{fb2} to V_{fb4}, respectively, representative of the output voltages Vₒᵤₜ₂ to Vₒᵤₜ₄. Based on differences between each of the feedback signals V_{fb2} to V_{fb4} and the reference voltage V_{ref}, the error amplifiers 12-2 to 12-4 generate error signals Vₑᵣᵣ₂ to Vₑᵣᵣ₄, respectively. Based on comparisons between each of the error signals Vₑᵣᵣ₂ to Vₑᵣᵣ₄ and the oscillating signal OSC, the PWM comparators 13-2 to 13-4 generate switching control signals PWM2 to PWM4, respectively. In response to each of the switching control signals PWM2 to PWM4, the switching circuits 14-2 to 14-4 convert the input voltage source Vin into the output voltages Vₒᵤₜ₂ to Vₒᵤₜ₄, respectively.

In the conventional multi-channel switching voltage converter 10, the oscillating signal generation circuit 15 generates only one oscillating signal OSC, such as a high frequency sawtooth wave. Such oscillating signal OSC is applied simultaneously to each of the power supply channels Ch1 to Ch4, i.e., simultaneously to the inverting input terminals of the PWM comparators 13-1 to 13-4. Since all of the power supply channels Ch1 to Ch4 are operated in accordance with the same oscillating signal OSC, the switching control signals PWM1 to PWM4 generated from the PWM comparators 13-1 to 13-4 are very much likely to overlap with respect to each other. As a result, the switching circuits 14-1 to 14-4 under the control of the switching control signals PWM1 to PWM4 are very much likely to switch ON/OFF at the same time, causing the transient spikes induced by switching operations to superpose together. Therefore, there is significantly large transient noise between the input voltage source Vin and ground, deteriorating qualities of the output voltages Vₒᵤₜ₁ to Vₒᵤₜ₄ and damaging the power supply channels Ch1 to Ch4.

### SUMMARY OF THE INVENTION

In view of the above-mentioned problems, an object of the present invention is to provide an oscillating signal generation circuit for a multi-channel switching voltage converter such that transient spikes induced by switching operations are prevented from superposing together and therefore a multi-channel switching voltage converter with relatively low noise is effectively achieved.

According to one aspect of the present invention, an oscillating signal generation circuit is provided for a multi-channel switching voltage converter. The oscillating signal generation circuit includes a rectangular wave oscillator, a first and a second frequency dividing units, and a first to a fourth oscillators. The rectangular wave oscillator generates a first fundamental rectangular wave and a second fundamental rectangular wave, which have an identical fundamental frequency but 180 degrees out of phase with respect to each other. In response to the first fundamental rectangular wave, the first frequency dividing unit generates a first auxiliary rectangular wave and a second auxiliary rectangular wave. The first and the second auxiliary rectangular waves have an identical auxiliary frequency but 180 degrees out of phase with respect to each other. The auxiliary frequency is equal to a half of the fundamental frequency. In response to the second fundamental rectangular wave, the second frequency dividing unit generates a third auxiliary rectangular wave and a fourth auxiliary rectangular wave. The third and the fourth auxiliary rectangular waves have the identical auxiliary frequency but 180 degrees out of phase with respect to each other. In response to the first auxiliary rectangular wave, the first oscillator generates a first oscillating signal wherein each valley of the first oscillating signal is triggered by an edge of the first auxiliary rectangular wave. In response to the third auxiliary rectangular wave, the second oscillator generates a second oscillating signal wherein each valley of the second oscillating signal is triggered by an edge of the third auxiliary rectangular wave. In response to the second auxiliary rectangular wave, a third oscillator generates a third oscillating signal wherein each valley of the third oscillating signal is triggered by an edge of the second auxiliary rectangular wave. In response to the fourth auxiliary rectangular wave, the fourth oscillator generates a fourth oscillating signal wherein each valley of the fourth oscillating signal is triggered by an edge of the fourth auxiliary rectangular wave.

According to another aspect of the present invention, a multi-channel switching voltage converter is disclosed to include 2ⁿ power supply channels and an oscillating signal generation circuit. Each of the 2ⁿ power supply channels converts an input voltage source into an output voltage, wherein n is an integer larger than or equal to 2. The oscillating signal generation circuit generates 2ⁿ oscillating signals whose phases are evenly distributed over one phase cycle of 360 degrees, for being supplied to the 2ⁿ power supply channels.

The oscillating signal generation circuit includes: a rectangular wave oscillator, 2^{m} m-th stage frequency dividing units, and 2ⁿ oscillators. The rectangular wave oscillator generates a first fundamental wave and a second fundamental wave whose an identical fundamental frequency but 180 degrees out of phase with respect to each other. The m is a set consisting of integers satisfying: 1≦m≦(n−1). Each of the 2^{m} m-th stage frequency dividing units is used for generating a pair of m-th stage auxiliary rectangular waves whose an identical m-th stage auxiliary frequency but 180 degrees out of phase with respect to each other. The m-th stage auxiliary frequency is equal to a half of the (m−1)-th auxiliary frequency except that a first auxiliary frequency is equal to a half of the fundamental frequency. In response to 2ⁿ (n−1)-th auxiliary rectangular waves generated from 2(n−1) (n−1)-th frequency dividing units, the 2ⁿ oscillators generate the 2ⁿ oscillating signals.

### BRIEF DESCRIPTION OF THE DRAWINGS

The above-mentioned and other objects, features, and advantages of the present invention will become apparent with reference to the following descriptions and accompanying drawings, wherein:

FIG. 1 is a circuit block diagram showing a conventional multi-channel switching voltage converter;

FIG. 2 is a circuit block diagram showing a multi-channel switching voltage converter according to the present invention;

FIG. 3 is a circuit block diagram showing an oscillating signal generation circuit according to the present invention;

FIG. 4 is a waveform timing chart showing an operation of an oscillating signal generation circuit according to the present invention;

FIG. 5 is a detailed circuit diagram showing a first sawtooth oscillator according to the present invention; and

FIG. 6 is a circuit block diagram showing an oscillating signal generation circuit for generating 2ⁿ oscillating signals according to the present invention.

### DETAILED DESCRIPTION OF THE PREFERRED EMBODIMENTS

The preferred embodiments according to the present invention will be described in detail with reference to the drawings.

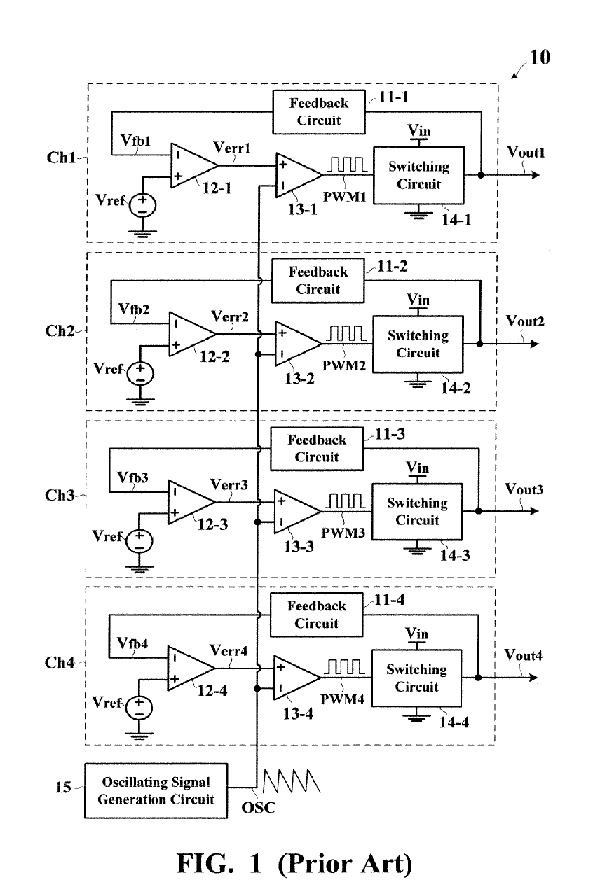

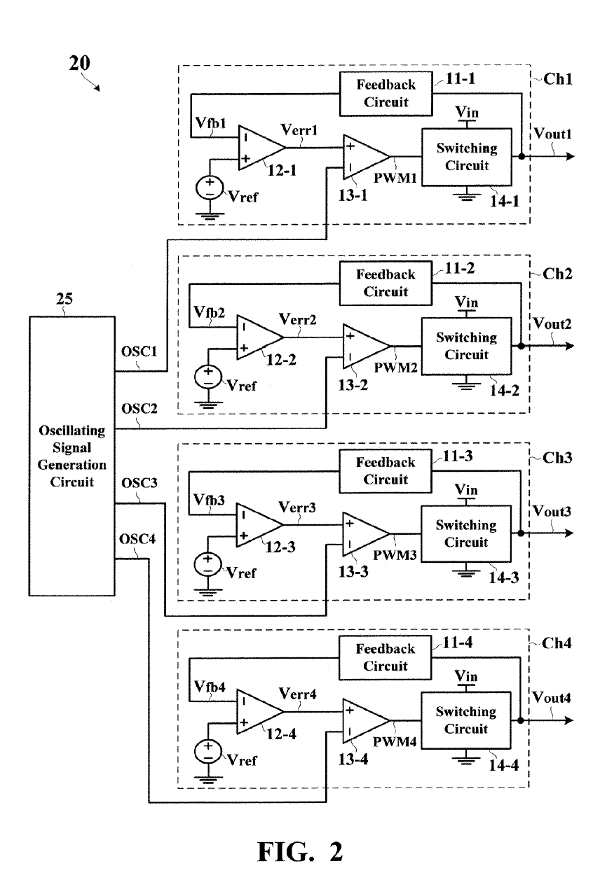

FIG. 2 is a circuit block diagram showing a multi-channel switching voltage converter 20 according to the present invention. Referring to FIG. 2, the multi-channel switching voltage converter 20 includes four power supply channels Ch1 to Ch4 and an oscillating signal generation circuit 25. The power supply channels Ch1 to Ch4 convert a single input voltage source Vin into four output voltages Vₒᵤₜ₁ to Vₒᵤₜ₄, respectively. Since the power supply channels Ch1 to Ch4 shown in FIG. 2 are similar to the power supply channels Ch1 to Ch4 shown in FIG. 1, any further descriptions in regard to circuit configuration and operation are omitted hereinafter.

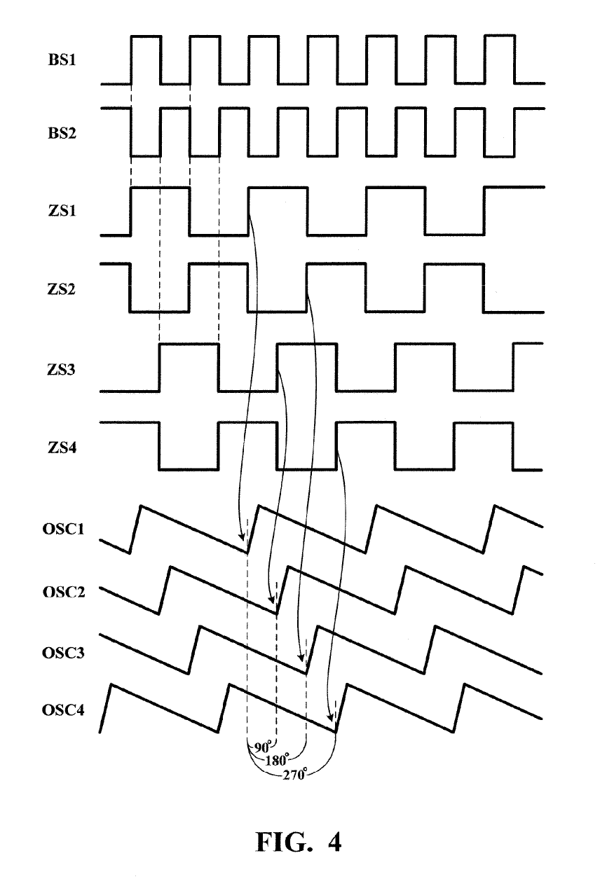

However, the oscillating signal generation circuit 25 shown in FIG. 2 is apparently different from the conventional oscillating signal generation circuit 15 shown in FIG. 1. More specifically, the oscillating signal generation circuit 25 generates four oscillating signals OSC1 to OSC4, respectively being applied to the power supply channels Ch1 to Ch4. The first to the fourth oscillating signals OSC1 to OSC4 are designed to have different phases with respect to each other (as shown in FIG. 4), such that the switching control signals PWM1 to PWM4 generated from the PWM comparators 13-1 to 13-4 of the power supply channels Ch1 to Ch4 are unlikely to overlap with respect to each other. As a result, the switching circuits 14-1 to 14-4 under the control of the switching control signals PWM1 to PWM4 are effectively prevented from switching ON/OFF at the same time, thereby reducing the transient spikes caused by switching operations.

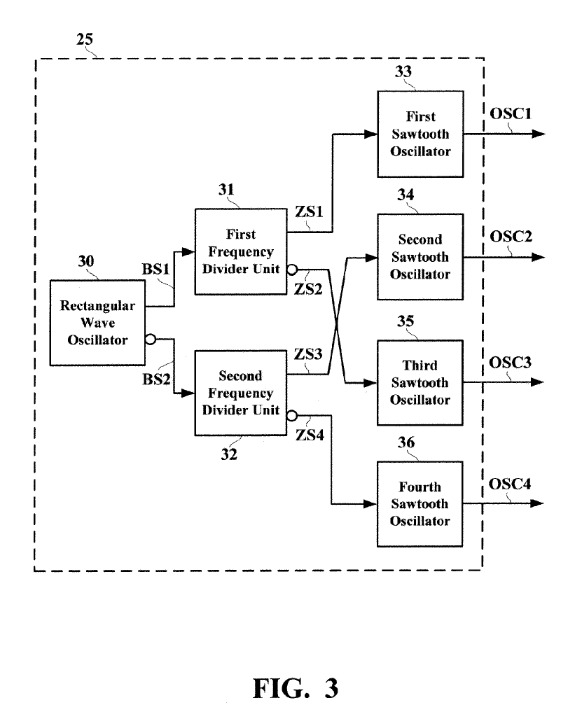

FIG. 3 is a circuit block diagram showing an oscillating signal generation circuit 25 according to the present invention. Referring to FIG. 3, the oscillating signal generation circuit 25 has a rectangular wave oscillator 30, a first and a second frequency dividing units 31 and 32, and a first to a fourth sawtooth oscillators 33 to 36. Hereinafter is described in detail an operation of the oscillating signal generation circuit 25 according to the present invention with reference to FIGS. 3 and 4.

The rectangular wave oscillator 30 has a non-inverting output terminal and an inverting output terminal. At a predetermined frequency, the rectangular wave oscillator 30 generates a pair of fundamental rectangular waves BS1 and BS2, which are 180 degrees out of phase with respect to each other. In other words, the first fundamental rectangular wave BS1 supplied from the non-inverting output terminal and the second fundamental rectangular wave BS2 supplied from the inverting output terminal have the asymmetric waveforms with respect to each other.

The first frequency dividing unit 31 has a non-inverting output terminal and an inverting output terminal. In response to the first fundamental rectangular wave BS1, the first frequency dividing unit 31 supplies a first auxiliary rectangular wave ZS1 through the non-inverting output terminal, and also supplies a second auxiliary rectangular wave ZS2 through the inverting output terminal. The first and the second auxiliary rectangular waves ZS1 and ZS2 have the same frequency which is equal to a half of the frequency of the first fundamental rectangular wave BS1. Likewise, the first and the second auxiliary rectangular waves ZS1 and ZS2 are 180 degrees out of phase with respect to each other and therefore have the asymmetric waveforms.

The second frequency dividing unit 32 has a non-inverting output terminal and an inverting output terminal. In response to the second fundamental rectangular wave BS2, the second frequency dividing unit 32 supplies a third auxiliary rectangular wave ZS3 through the non-inverting output terminal, and also supplies a fourth auxiliary rectangular wave ZS4 through the inverting output terminal. The third and fourth auxiliary rectangular waves ZS3 and ZS4 have the same frequency which is equal to a half of the frequency of the second fundamental rectangular wave BS2. Likewise, the third and the fourth auxiliary rectangular waves ZS3 and ZS4 are 180 degrees out of phase with respect to each other and therefore have the asymmetric waveforms.

Therefore, as clearly seen from FIG. 4, if the first auxiliary rectangular wave ZS1 is held as a reference signal, then the third auxiliary rectangular wave ZS3 has 90 degrees in phase ahead of the first auxiliary rectangular wave ZS1; the second auxiliary rectangular wave ZS2 has 180 degrees in phase ahead of the first auxiliary rectangular wave ZS1; the fourth auxiliary rectangular wave ZS4 has 270 degrees in phase ahead of the first auxiliary rectangular wave ZS1. In other words, the phases of the first to the fourth auxiliary rectangular waves ZS1 to ZS4 are evenly distributed over one phase cycle of 360 degrees, such that their rising edges (or falling edges) are non-overlapping with respect to each other.

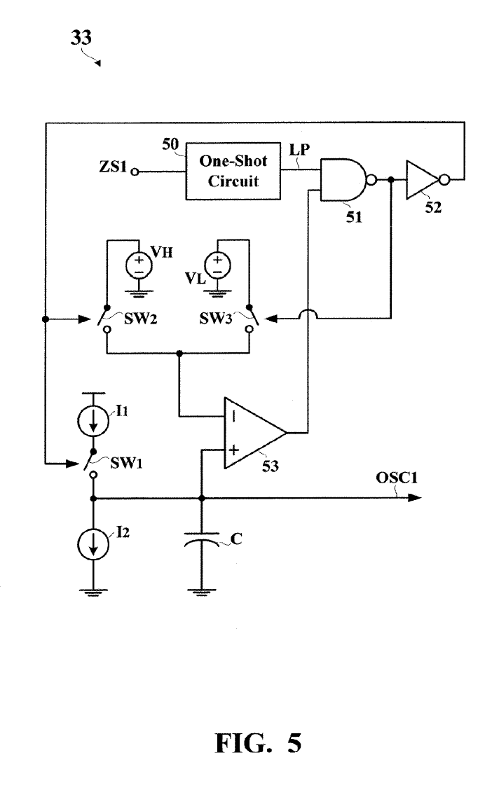

The first auxiliary rectangular wave ZS1 is applied to the first sawtooth oscillator 33 to trigger the generation of the first oscillating signal OSC1. More specifically, each of the rising edges of the first auxiliary rectangular wave ZS1 corresponds in time to each of the valleys of the first oscillating signal OSC1. Therefore, the frequency and phase of the first oscillating signal OSC1 are determined on the basis of the first auxiliary rectangular wave ZS1. The ratio of the rising portion to the falling portion of the first oscillating signal OSC1 is determined by an upper limit voltage V_{H} set in the first sawtooth oscillator 33, which will be described in detail with reference to FIG. 5.

The third auxiliary rectangular wave ZS3 is applied to the second sawtooth oscillator 34 to trigger the generation of the second oscillating signal OSC2. More specifically, each of the rising edges of the third auxiliary rectangular wave ZS3 corresponds in time to each of the valleys of the second oscillating signal OSC2. Therefore, the frequency and phase of the second oscillating signal OSC2 are determined on the basis of the third auxiliary rectangular wave ZS3. The ratio of the rising portion to the falling portion of the second oscillating signal OSC2 is determined by an upper limit voltage V_{H} set in the second sawtooth oscillator 34, which will be described in detail later.

The second auxiliary rectangular wave ZS2 is applied to the third sawtooth oscillator 35 to trigger the generation of the third oscillating signal OSC3. More specifically, each of the rising edges of the second auxiliary rectangular wave ZS2 corresponds in time to each of the valleys of the third oscillating signal OSC3. Therefore, the frequency and phase of the third oscillating signal OSC3 are determined on the basis of the second auxiliary rectangular wave ZS2. The ratio of the rising portion to the falling portion of the third oscillating signal OSC3 is determined by an upper limit voltage V_{H} set in the third sawtooth oscillator 35, which will be described in detail later.

The fourth auxiliary rectangular wave ZS4 is applied to the fourth sawtooth oscillator 36 to trigger the generation of the fourth oscillating signal OSC4. More specifically, each of the rising edges of the fourth auxiliary rectangular wave ZS4 corresponds in time to each of the valleys of the fourth oscillating signal OSC4. Therefore, the frequency and phase of the fourth oscillating signal OSC4 are determined on the basis of the fourth auxiliary rectangular wave ZS4. The ratio of the rising portion to the falling portion of the fourth oscillating signal OSC4 is determined by an upper limit voltage V_{H} set in the fourth sawtooth oscillator 36, which will be described in detail later.

Therefore, as clearly seen from FIG. 4, if the first oscillating signal OSC1 is held as a reference signal, then the second to the fourth oscillating signals OSC2 to OSC4 have 90, 180, and 270 degrees, respectively, in phase ahead of the first oscillating signal OSC1. In other words, the phases of the first to the fourth oscillating signals OSC1 to OSC4 are evenly distributed over one phase cycle of 360 degrees, such that their rising edges (or falling edges) are non-overlapping with respect to each other.

Because the first to the fourth sawtooth oscillators 33 to 36 have the same circuit configuration and operation, the following description is taking the first sawtooth oscillator 33 as an example and will be applicable to the other sawtooth oscillators 34 to 36. FIG. 5 is a detailed circuit diagram showing a first sawtooth oscillator 33 according to the present invention. Referring to FIG. 5, each operation cycle of the first sawtooth oscillator 33 consists of a rising phase and a falling phase.

The rising phase is executed to generate the rising portion of the first oscillating signal OSC1, i.e., from the valley up to the peak. The first auxiliary rectangular wave ZS1 is applied to a one-shot circuit 50 such that the rising edge of the first auxiliary rectangular wave ZS1 triggers the one-shot circuit 50 to generate an one-shot pulse LP with a narrow width at a low level. The low-level one-shot pulse LP makes a NAND logic gate 51 output a high level and then makes an inverter 52 output a low level. The output signal of the inverter 52 controls a first switch SW₁ and a second switch SW₂ while the output signal of the NAND logic gate 51 controls a third switch SW₃. When the output signal of the inverter 52 is at the low level, the first switch SW₁ is turned ON such that a first current source I₁ charges a capacitor C and the second switch SW₂ is turned ON such that a predetermined upper limit voltage V_{H} is applied to an inverting input terminal of a comparator 53. Therefore, a potential difference across the capacitor C gradually increases. Such potential difference is output for serving as the rising portion of the first oscillating signal OSC1, and is also applied to a non-inverting input terminal of the comparator 53. As soon as the potential difference across the capacitor C exceeds the upper limit voltage V_{H}, the first oscillating signal OSC1 reaches the peak and the output signal of the comparator 53 makes a transition to the high level.

The falling phase is executed to generate the falling portion of the first oscillating signal OSC1, i.e., from the peak down to the valley. After the output signal of the comparator 53 makes a transition to the high level, the NAND logic gate 51 outputs the low level and the inverter 52 outputs the high level. When the output signal of the inverter 52 is at the high level, the first switch SW₁ is turned OFF such that the capacitor C is discharged through a second current source I₂ and the second switch SW₂ is turned OFF such that a predetermined lower limit voltage V_{L} is applied to the inverting input terminal of the comparator 53. Therefore, the potential difference across the capacitor C gradually decreases. Such potential difference is output for serving as the falling portion of the first oscillating signal OSC1, and is also applied to a non-inverting input terminal of the comparator 53. As soon as the rising edge of the first auxiliary rectangular wave ZS1 triggers the one-shot circuit 50 again, the low-level one-shot pulse LP makes the NAND logic gate 51 output the high level and makes the inverter 52 output the low level, thereby finishing the present cycle and starting the rising phase of the next cycle.

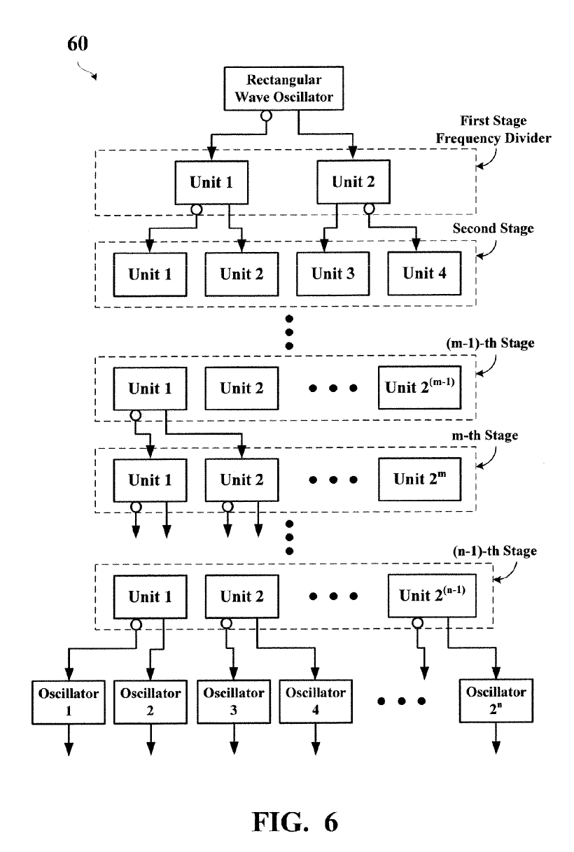

It should be noted that the multi-channel switching voltage converter 20 according to the present invention is not limited to the four power supply channels shown in FIG. 2, and may be generally applied to a switching voltage converter with 2ⁿ power supply channels wherein n is an integer larger than or equal to 2. FIG. 6 is a circuit block diagram showing an oscillating signal generation circuit 60 for generating 2ⁿ oscillating signals according to the present invention. Such 2ⁿ oscillating signals have phases evenly distributed over one phase cycle of 360 degrees, i.e. any two adjacent oscillating signals have a phase difference of 360/(2ⁿ) degrees, such that their valleys (or peaks) are non-overlapping with respect to each other. The oscillating signal generation circuit 60 firstly generates a pair of fundamental rectangular waves with a fundamental frequency f₀, secondly executes the frequency dividing operations as many as (n−1) times, and finally generates 2ⁿ auxiliary rectangular waves. Since the 2ⁿ oscillating signals are generated in accordance with the triggering of the 2ⁿ auxiliary rectangular waves, each of the 2ⁿ oscillating signals has the same frequency of f₀/(2⁽ⁿ⁻¹⁾).

For example, when the oscillating signal generation circuit is applied to generate 8(=2³, n=3) oscillating signals for 8 power supply channels, each of the first to the fourth auxiliary rectangular waves shown in FIG. 3 needs to be subjected to a second stage frequency dividing operation, which is similar to the first stage frequency dividing operation that the first (or the second) frequency dividing unit performs with respect to the first (or the second) fundamental rectangular wave, so as to generate 8 auxiliary rectangular waves. Such 8 auxiliary rectangular waves have phases evenly distributed over one phase cycle of 360 degrees and therefore any two adjacent auxiliary rectangular waves have a phase difference of 45 degrees.

Referring to FIG. 6, the oscillating signal generation circuit 60 has a rectangular wave oscillator, 2^{m} m-th stage frequency dividing units, and 2ⁿ oscillators. The rectangular wave oscillator generates a first fundamental rectangular wave and a second fundamental rectangular wave, which have the same fundamental frequency but 180 degrees out of phase with respect to each other. The 2^{m} m-th stage frequency dividing units include 2 first stage frequency dividing units, 4 second stage frequency dividing units, . . . , and 2⁽ⁿ⁻¹⁾ (n−1)-th stage frequency dividing units. That is, m is a set consisting of integers satisfying: 1≦m≦(n−1). Each of the m-th stage frequency dividing units is provided for generating a pair of m-th stage auxiliary rectangular waves, which have the same m-th stage frequency but 180 degrees out of phase with respect to each other. The m-th stage auxiliary frequency is equal to a half of the (m−1)-th stage auxiliary frequency, except that the first stage auxiliary frequency is equal to a half of the fundamental frequency. In other words, responding to the fundamental rectangular waves of the rectangular wave oscillator, the first stage frequency dividing unit generates the first stage auxiliary rectangular waves. Finally, in response to the (n−1)-stage auxiliary rectangular waves generated from the 2⁽ⁿ⁻¹⁾(n−1)-th stage frequency dividing units, the 2ⁿ oscillators generate the 2ⁿ oscillating signals, respectively.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. An oscillating signal generation circuit applied for a multi-channel switching voltage converter, comprising:
a rectangular wave oscillator for generating a first fundamental rectangular wave and a second fundamental rectangular wave, which have an identical fundamental frequency but 180 degrees out of phase with respect to each other;
a first frequency dividing unit for generating a first auxiliary rectangular wave and a second auxiliary rectangular wave in response to the first fundamental rectangular wave, wherein the first and the second auxiliary rectangular waves have an identical auxiliary frequency but 180 degrees out of phase with respect to each other, and the auxiliary frequency is equal to a half of the fundamental frequency;
a second frequency dividing unit for generating a third auxiliary rectangular wave and a fourth auxiliary rectangular wave in response to the second fundamental rectangular wave, wherein the third and the fourth auxiliary rectangular waves have the identical auxiliary frequency but 180 degrees out of phase with respect to each other;
a first oscillator for generating a first oscillating signal in response to the first auxiliary rectangular wave, wherein each valley of the first oscillating signal is triggered by an edge of the first auxiliary rectangular wave;
a second oscillator for generating a second oscillating signal in response to the third auxiliary rectangular wave, wherein each valley of the second oscillating signal is triggered by an edge of the third auxiliary rectangular wave;
a third oscillator for generating a third oscillating signal in response to the second auxiliary rectangular wave, wherein each valley of the third oscillating signal is triggered by an edge of the second auxiliary rectangular wave; and
a fourth oscillator for generating a fourth oscillating signal in response to the fourth auxiliary rectangular wave, wherein each valley of the fourth oscillating signal is triggered by an edge of the fourth auxiliary rectangular wave.

2. The oscillating signal generation circuit according to claim 1, wherein:
each valley of the first oscillating signal is triggered by a rising edge of the first auxiliary rectangular wave.

3. The oscillating signal generation circuit according to claim 1, wherein:
each valley of the second oscillating signal is triggered by a rising edge of the third auxiliary rectangular wave.

4. The oscillating signal generation circuit according to claim 1, wherein:
each valley of the third oscillating signal is triggered by a rising edge of the second auxiliary rectangular wave.

5. The oscillating signal generation circuit according to claim 1, wherein:
each valley of the fourth oscillating signal is triggered by a rising edge of the fourth auxiliary rectangular wave.

6. The oscillating signal generation circuit according to claim 1, wherein:
each of the first to the fourth oscillators is implemented by a sawtooth oscillator.

7. The oscillating signal generation circuit according to claim 1, wherein:
each of the first to the fourth oscillating signals is implemented by a sawtooth wave.

8. A multi-channel switching voltage converter, comprising:
2ⁿ power supply channels, each of which converts an input voltage source into an output voltage, wherein n is an integer larger than or equal to 2; and
an oscillating signal generation circuit for generating 2ⁿ oscillating signals whose phases are evenly distributed over one phase cycle of 360 degrees, for being supplied to the 2ⁿ power supply channels;
characterized in that:
the oscillating signal generation circuit includes:
a rectangular wave oscillator for generating a first fundamental wave and a second fundamental wave whose an identical fundamental frequency but 180 degrees out of phase with respect to each other;
2^{m} m-th stage frequency dividing units, wherein the m is a set consisting of integers satisfying: 1≦m≦(n−1), and each of the 2^{m} m-th stage frequency dividing units is used for generating a pair of m-th stage auxiliary rectangular waves whose an identical m-th stage auxiliary frequency but 180 degrees out of phase with respect to each other, wherein the m-th stage auxiliary frequency is equal to a half of the (m−1)-th auxiliary frequency except that a first auxiliary frequency is equal to a half of the fundamental frequency; and
2ⁿ oscillators for generating the 2ⁿ oscillating signals in response to 2ⁿ (n−1)-th auxiliary rectangular waves generated from 2(n−1) (n−1)-th frequency dividing units.

9. The multi-channel switching voltage converter according to claim 8, wherein:
a valley of each of the 2ⁿ oscillating signals is triggered by a rising edge of each of the 2ⁿ (n−1)-th auxiliary rectangular waves.

10. The multi-channel switching voltage converter according to claim 8, wherein:
each of the 2ⁿ oscillating signals is implemented by a sawtooth wave.
